(19) United States
(12) Patent Application Publication
(10) Pub. No.: US 2010/0183159 A1
(43) Pub. Date: Jul. 22, 2010

(54) Method and System for Spatialization of Sound by Dynamic Movement of the Source

(75) Inventors: Vincent Clot, Den Haag (NL); Jean-Noël Perbet, Eysines (FR); Pierre-Albert Breton, Pessac (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/612,589

(22) Filed: Nov. 4, 2009

(30) Foreign Application Priority Data
Nov. 7, 2008 (FR) 08 06229

(51) Int. Cl. H04R 29/00; G01C 23/00; G01C 21/00; H04R 5/00

(52) U.S. Cl. 381/56; 340/971; 701/200

(57) ABSTRACT

The invention relates to a method and the system for algorithmic processing of signals for sound spatialization making it possible to associate sound signals with information that has to be located by a listener, the spatialized sound signals being defined by a virtual position of origin corresponding to the position of the information wherein by algorithmic processing, a spatialized sound signal has an oscillatory movement applied to it describing a sequence of virtual positions of the said signal around the virtual position of origin.

The invention applies to man-machine interface applications, notably in a cockpit avionics system.

It makes it possible to better locate the information by associating with it a spatialized sound item of information.

### PRIORITY CLAIM

This application claims priority to French Patent Application Number 08 06229, entitled Method and System for Spatialization of Sound by Dynamic Movement of the Source, filed on Nov. 7, 2008.

### FIELD OF THE INVENTION

The field of the invention relates to a method for algorithmic processing of signals for sound spatialization making it possible to improve the localization of virtual positions of origin of sound signals. Hereinafter the term sound spatialization or 3D sound will be used. The invention applies notably to the spatialization systems that are compatible with an item of avionic modular equipment for processing information of the IMA type (Integrated Modular Avionics).

### BACKGROUND OF THE INVENTION

In the field of on-board aeronautics and notably in the military field, most of the thinking culminates in the need for a head-up visual which can be a helmet worn on the head, associated with a very large format display presented head down. This assembly should make it possible to improve the perception of the overall situation (“situation awareness”) while reducing the load on the pilot thanks to a presentation of a real time summary of the information originating from multiple sources (sensors, database).

3D sound forms part of the same approach as helmet display by allowing pilots to acquire spatial situation information in its own coordinate system via a communication channel other than the visual by following a natural modality that is less heavily loaded than the vision.

Typically in the context of military aeronautics applications, warplanes comprise threat-detection systems such as a radar lock-on by an enemy aircraft or a risk of collision, associated with display systems inside the cockpit. These systems warn the pilot of threats in his environment, by display on a display element combined with a sound signal. 3D sound techniques provide an indication of localization of the threat via the hearing input channel which is not overloaded and is intuitive. The pilot is therefore informed of the threat by means of a spatialized sound in the direction corresponding to the information.

For on-board aeronautics applications, a sound spatialization system consists in a computing system carrying out algorithmic processes on the sound signals. The crowdedness of aircraft cockpits limits the integration of audio equipment and consequently systems of multiple loudspeaker networks and/or of mobile loudspeakers allowing spatialization without algorithmic processing are very little used for the delivery of 3D sounds.

Various algorithmic sound-spatialization processes are currently used to simulate the positioning of sounds in the environment of an individual:
the techniques for generating binaural signals are based on the sound level difference (ILD for Interaural Level Difference) between the auditory receptors of an individual and on the reception time difference of the sound signals (ITD for Interaural Time Difference) between these same receptors. FIG. 1 illustrates a series of curves representing the interaural level differences as a function of the frequencies of the sound for a listener depending on the position of the sound sources. For a sound A1 in front of the listener, the curve c1 represents the curve of the sound as a function of the frequencies. The curve c2 corresponds to the sound A2 and the curve c3 corresponds to the sound A3.
the complementary techniques for generating monaural signals cause the spectrum of the sound wave to vary as a function of its position by applying to it the anatomical transfer function of the individual (HRTF for Head Related Transfer Functions). The anatomical transfer function incorporates the effects of secondary dispersion such as the outer ears, the shoulders, the shape of the skull, etc. Taking account of the HRTF makes it possible to increase the sensitivity to the elevation of a sound and the front-back discrimination. As an example, FIG. 2 shows a series of HRTF curves for various positions of the sound source. The curve c11 represents the HRTF function for the sound located at A11. The curve c12 represents the HRTF function for the sound located at A12. The curve c13 represents the HRTF function for the sound located at A13.

Those skilled in the art are familiar with these sound spatialization techniques which are not the subject of the invention. However, for information, it is possible to cite the publications “Adaptative 3D sound systems” by John Garas, published by Kluwer Academic Publishers, and “Signals, Sound, and Sensation” by Bill Hartmann, published by AIP Press describing the latter techniques.

Also known is Patent WO 2004/006624 A1 describing an avionic 3D sound system which, to increase detection of the position of sound, makes use of an HRTF database.

Current sound spatialization systems have performance limitations in localization and often the disadvantage of an ambiguous sound source localization. In particular, the performance in locating a sound played in front of a listener from a sound played behind a listener and, in the same manner, in elevation remain variable from one individual to another and are generally unsatisfactory.

Scientific studies have shown what dynamic signals can bring to localization in elevation and front-back. A dynamic signal is a sound signal which does not have a constant localization relative to the individual. This work is inspired by certain animals which have a reputation for their auditory capabilities, notably felines which move their auditory receptors in order to locate the sound sources. In order to illustrate the various work projects carried out on dynamic signals with humans, it is possible to cite notably H. Wallach with “The role of head movements and vestibular and visual cues in sound localization”, J. Exp. Psychol. Vol. 27, 1940, pages 339-368, W. R. Thurlow and P. S. Runge with “Effects of induced head movements on localization of direct sound”, The Journal of the Acoustical Society of America, Vol. 42, 1967, pages 480-487/489-493 and S. Perrett and W. Noble with “The effect of head rotations on vertical plane sound localization”, The Journal of the Acoustical Society of America, Vol. 102, 1997, pages 2325-2332.

The article entitled “Resolution of front-back ambiguity in spatial hearing by listener and source movement”, by F. L. Wightman and D. J. Kistler, which appears in The Journal of the Acoustical Society of America, Volume 105, Issue 5, pages 2841-2853, in May 1999, summarizes the work done in fifty years on what dynamic signals bring to the localization of sounds. This study shows empirically that the movement of the subject, head movement for example, reduces confusion in front and back localization, that the multidirectional movement of the source at the initiative of a subject forced to remain immobile reduces confusion in front and back localization and the continuous monodirectional movement of the source by an action external to the subject, that cannot be controlled by the subject, does not significantly reduce the confusion in front-back localization.

However, in the aeronautics field and particularly for pilots, it is not always possible for him to move his head sufficiently because of the restricted clearance space in the cockpits and because of the electronic systems built into the helmet. The task of the pilot, requiring his full concentration on the systems and his field of vision, is also a factor of constraint to movements. The heavy load factors under acceleration also limit the movements of the pilot and in particular of his head.

### SUMMARY OF THE INVENTION

The object of the present invention is to prevent the ambiguities of localization of a sound source.

More precisely, the invention relates to a method for algorithmic processing of signals for sound spatialization making it possible to associate sound signals with information that has to be located by a listener. The spatialized sound signals are defined by a virtual position of origin corresponding to the position of the information. By algorithmic processing, a spatialized sound signal has a movement applied to it describing a sequence of virtual positions of the said signal around the virtual position of origin of the information.

Preferably, the movement around the virtual position of origin of the information is of the oscillatory type.

In a second computation mode, the movement around the virtual position of origin of the information is of the Random type.

This solution for improving the localization of 3D sounds is designed particularly for listeners who are subjected to constraints of movement and of workload. In a natural manner, a listener gives movement to his auditory receptors in order to localize a sound better. The invention allows the listener to remain immobile. Specifically, the virtual position of origin being the spatialized position of the sound, the movement of the sound source around this position provides better localization information than that of a continuous monodirectional movement.

For aeronautics applications, the spatialization system may also be coupled with a device for detecting the position of the pilot's helmet. Advantageously, the movement is then correlated with the angle of deviation between the listening direction of the listener and the virtual position of origin of the said sound signal. The movement then varies as a function of the orientation of the pilot with respect to the information to be detected which is associated with the sound signal.

Preferably, the amplitude of the movement is correlated with the value of the said angle of deviation and the orientation of the movement is also correlated with the orientation of the plane of the said angle of deviation. The pilot therefore receives information telling him whether he is orienting himself in the direction of the information to be acquired.

Moreover, during the movement of the spatialized signal, a law of variation of the sound intensity is also applied to the spatialized signal in which:
the sound intensity is between a maximum level and a minimum level.
the level is maximum when the sound signal corresponds to the virtual position of origin.
the level is minimum for the extreme positions of the oscillatory movement.

This sound spatialization effect simulates a movement of the sound signal converging on the virtual position of origin of the information. This dynamic effect improves the detection of the sound.

The invention also relates to the system for algorithmic processing of signals for sound spatialization comprising a first sound spatialization computation means making it possible to associate sound signals with information that has to be located by a listener. The said system is characterized in that it comprises a second trajectory computation means supplying data making it possible for the first spatialization computation means to apply a movement to a spatialized sound signal around its virtual position of origin. This movement of the sound signal is preferably oscillatory.

The system also comprises a third means for computing at least one law of variation of the intensity of a sound signal in order to modify the intensity of the spatialized sound signal during the oscillatory movement.

Preferably, it also comprises a means for receiving position data and the second trajectory-computation means computes the difference in distance between the virtual position of origin of the sound source and the position supplied by the reception means and computes a movement in correlation with the said difference in distance.

In a first embodiment, the means for receiving position data is linked to a detector of the position of a helmet worn by a listener.

In a second embodiment, the means for receiving position data is linked to a camera that is detecting the positioning of the listener. This camera is not worn by the listener.

In one aeronautics application mode, the sound signals originate from a sound database of the aircraft and the said sound signals are associated with information of at least one avionics device.

A first avionics device is a display device.

A second avionics device is a navigation device.

A third avionics device is a warning device.

### BRIEF DESCRIPTION OF THE DRAWINGS

The invention will be better understood and other advantages will appear on reading the following description given in a non-limiting manner and by virtue of the appended figures amongst which:

FIG. 3 represents the spatialization system for a computer system. The example applies notably to an avionics system.

FIG. 4 illustrates a warning situation in an aircraft cockpit and an application of the sound spatialization system.

FIG. 5 represents an aeronautics application of the spatialization system and notably the oscillation of a sound signal around a virtual position of origin. This diagram illustrates the variation of the oscillation movement as a function of the position of the pilot with respect to the virtual position of origin of the sound signal and the variation in intensity of the signal as a function of the virtual position of the sound signal in the oscillatory movement.

FIG. 6 illustrates the difference in arrival time of the sounds at the ears of a listener according to the position of the sounds.

FIG. 7 represents the effect simulated by the variation in sound intensity on the oscillatory movement.

### DETAILED DESCRIPTION OF PREFERRED EMBODIMENT

The invention relates to sound spatialization systems and a method for improving the localization of a sound in the environment of a listener. The results obtained by empirical method show that an individual more easily detects the origin of a sound when it is in movement The aforementioned works show the best results in the localization tests with a sound in continuous movement. The essential feature of the spatialization method is to confer an oscillatory movement on a sound around its virtual position of origin.

The needs in the aeronautics field, notably for the man-machine interfaces with respect to the cockpit, approve particularly the sound spatialization techniques for improving the interaction of the piloting systems with the crew. The complexity of these systems, the multiple functions for navigation, for safety management and for manoeuvres swamp the pilot with information. This information may originate from display systems, from warning light indicators, from interaction systems and also from co-pilots and navigating crews for communications. 3D sound techniques make it possible to provide an indication of the position of an item of information. Therefore the pilot is better able to perceive its origin, its priority and the nature of the action to be taken as a consequence.

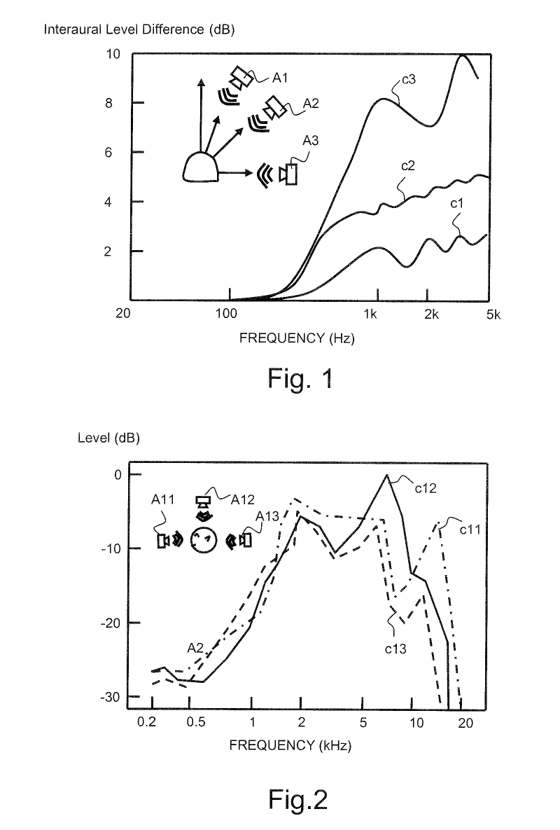

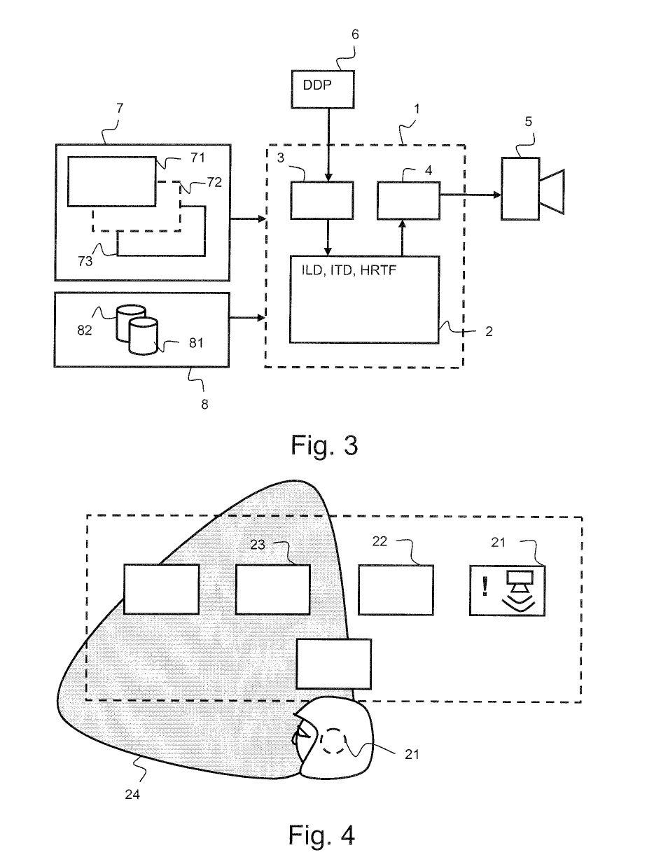

Within an aircraft cockpit, a sound spatialization system is situated on the border between the avionics systems and the man-machine interface. FIG. 3 schematizes a spatialization system in an aircraft cockpit and particularly in a warplane in which the pilot wears a helmet incorporating a device 6 for detecting the position of the helmet. This type of aircraft comprises several avionics systems 7, notably warning systems 71 associated with navigation making it possible to avoid collisions and systems dedicated to military operations such as target detection devices 72 and target attack devices. The avionics systems may also include a meteorology device 73. These systems are most frequently coupled to display devices. FIG. 3 does not show all the avionics systems that can be associated with the spatialization system. Those skilled in the art know the avionics architectures and are capable of using a sound spatialization system with any avionics device transmitting information to the pilot.

FIG. 4 schematizes a particular situation showing the value of a spatialized system with an anti-collision system. The field of vision 24 of the pilot to the controls of the aircraft is oriented towards the left at a given moment. This pilot has a loudspeaker system 21 positioned inside the helmet at his ears. The cockpit of the aircraft comprises several displays 21-23 and the field of vision of the pilot is oriented towards the display 23. For example, an event such as a risk of collision with the ground detected by the anti-collision system warns the pilot by displaying on the display 21 the hazardous situation with the navigation data to be monitored and the flight settings to be established. The system also transmits audible warnings associated with the screen information. The spatialized sound associated with the warnings tells the pilot of the localization of the information to be taken into account and thereby reduces his mental workload by virtue of the audio stimulus given by the spatialization system. The pilot's reaction time is thus reduced.

A sound spatialization system 1 is usually associated with a sound reception device and a sound database system 81 storing pre-recorded sounds, such as synthesized warning messages, signalling sounds, software application sounds or sounds originating from communication systems both inside and outside the aircraft. As an example, the spatialization of the audio communications gives additional information on the person with whom the pilot is in communication.

The sound delivery system 5 comprises earphones inside the pilot's helmet and also comprises the cockpit loudspeaker system. For the use of the binaural sounds in the spatialization system, the sound delivery system must be of the stereophonic type for the application of the time difference effects of the signals between the loudspeakers.

The output of the spatialization module also comprises a signal-processing device making it possible to add additional effects to the spatialized signals, such as Tremolo effects or Doppler effect for example.

The sound spatialization computation means 2 carries out the algorithmic processes of the sounds in order to generate the monaural signals, making the change in the sound intensity, the binaural signals, making the change in phase of the signals in order to simulate a time difference and the application of the anatomical transfer functions (HRTF).

The binaural signals are used for the localization of the sound sources in azimuth and require a stereophonic delivery system. Amongst the binaural signals, the computation means establish an algorithmic processing making it possible to simulate a distance from the sound sources by modifying the sound level (ILD) and a time difference between the sounds (ITD).

The monaural signals are used for localization in elevation and for distinguishing a sound source positioned in front of or behind the listener. The monaural signals do not require any stereophonic delivery system. The spatialization system is connected to an HRTF database 82 storing the anatomical transfer functions of the known pilots. These transfer functions may be tailored for each pilot by an individual measurement. The database may also comprise several typical anatomical profiles for the purpose of being correlated with a pilot when the system is used for the first time in order to detect the adapted profile. This manipulation is quicker than the individual measurement.

Those skilled in the art know the various techniques and signal-processing algorithms generated by the computation means 2 for sound spatialization.

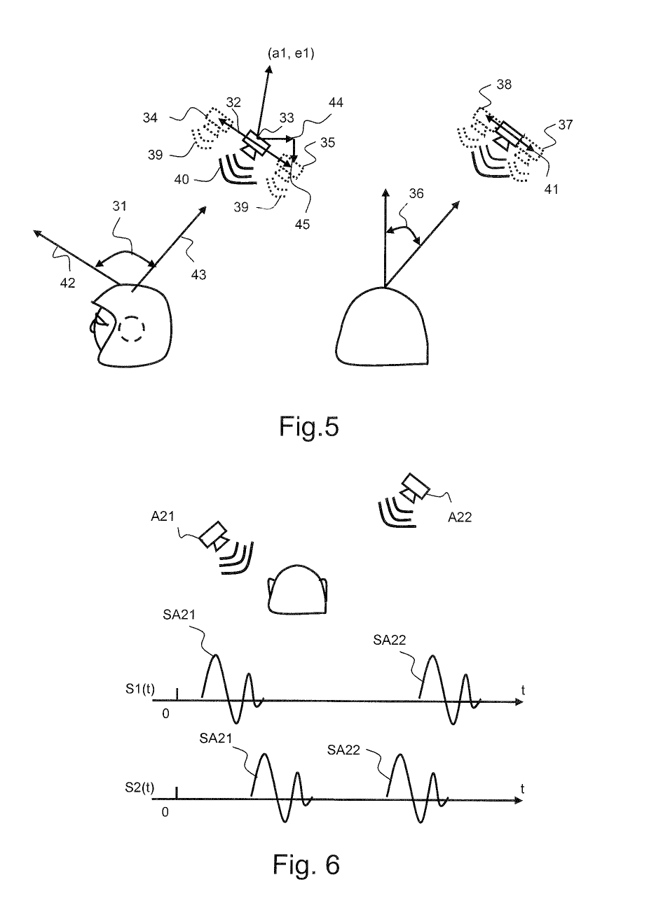

To apply the invention, two functional means 3 and 4 complete the spatialization computation means. The first means 3 has the function of computing the trajectory of the oscillatory movement before being conferred on the spatialized sound. The oscillatory movement comprises a trajectory that can vary in elevation and in azimuth relative to the listener. The oscillatory trajectory is in an angular range the apex of the angle of which is centred on the listener. For an aircraft cockpit application comprising a position detector 6 of the pilot's helmet, the computation means 3 determines an angle of deviation between the orientation in which the pilot is looking, indirectly by the position of the helmet, and the virtual position of origin of the sound signal. FIG. 5 schematizes the application of the invention for the computation of the trajectory of the oscillatory movement. The drawing on the left represents the situation in which the orientation of the pilot is such that the direction of his field of vision 42 is greatly decorrelated from the direction 43 of his field of vision if the latter were oriented towards the position of origin of the sound signal. The angle of deviation 31 is computed by the computation means 3. This angle of deviation may be in a plane varying in azimuth and in elevation as a function of the orientation 42 of the field of vision of the pilot. The computation means 3 also generates the trajectory of the oscillatory movement 32 as a function of this angle of deviation 31.

The trajectory of the oscillatory movement 32, or 41 in the drawing on the right of FIG. 5, is a function of the angle of deviation 31, or 36. The coordinates of the virtual position of origin 33 are defined by a coordinate in azimuth al and a coordinate in elevation e1. Preferably, the trajectory of the oscillatory movement 32 is bidirectional and continuous, thereby making a back-and-forth oscillatory movement in an arc of a circle linked to the angular steps 44 and 45. However, the trajectory computation means may define a trajectory that can be oval or of another shape. The speed of scanning of this trajectory can also be configured. It is preferably greater than the speed of movement of the head with a latency of less than 70 ms in order to preserve the naturalness of the sound.

The law defining the trajectory of movement depends on angular steps that can be defined, as a non-limiting example, in the following manner:

If the angle of deviation 31 is greater than 45°, the angular position relative to where the pilot is looking varies by 15°.

If the angle of deviation 31 is between 45° and 20°, the angular position relative to where the pilot is looking varies by 10°.

If the angle of deviation 31 is between 20° and 10°, the angular position relative to where the pilot is looking varies by 5°.

If the angle of deviation 31 is between 10° and 0°, the angular position relative to where the pilot is looking varies by 2°.

When the angle of deviation 31 is equal to 0°, the sound source no longer moves.

When the trajectory of the oscillatory movement is determined by angular steps, the spatialization process computes, via the computation means 2, the trajectory of the oscillatory movement 32 around the virtual position 33. The computed angles are used by the functions for computing monaural and binaural signals in order to determine the trajectory 32 around the virtual position of origin 33. This trajectory 32 comprises a series of several virtual positions delimited by two extreme positions 34 and 35. These two extreme positions are localized according to the coordinates of the position of origin 33 plus angular steps in azimuth 44 and elevation 45. The ITD and ILD signals depend on the angles in azimuth and elevation.

To understand the operation of the spatialization module 3, it is necessary to define the sound signals initially. In an aeronautics application of sound spatialization, a sound signal is defined as a vibration perceived by the human ear, described in the form of a sound wave and being able to be represented in the temporal and frequential field (wave spectrum). Mathematically, a sound signal is defined by the formula (1):

$$S ( t ) = {\sum }_{i} {a}_{i} \cdot cos ( 2 π \cdot {f}_{i} \cdot t + {Φ}_{i} ) = f ( t )$$

where αᵢ is the amplitude of the i^{th} harmonic, ƒᵢ its frequency and Φᵢ its phase at the origin.

Computation of the Interaural Time Difference (ITD):

The ITD signals comprise a phase modification in order to simulate a position in azimuth that is different by means of a time difference of the signal between the ears of a listener. A phase difference ΔΦ corresponds to an interaural time difference (ITD) of Δt=ΔΦ/(2πƒ) for a sound of frequency ƒ.

If the head is assimilated to a sphere and waveforms of sufficient length are considered, the interaural time difference is equal to

$$Δ t = \frac{3 a}{c} \cdot sin θ .$$

where θ is the angle in azimuth, a the radius of the head, approximately 8.75 cm, and C the speed of the sound, 344 m/s. Therefore 3a/c=763 μs approximately.
FIG. 6 represents the time diagram of the sound for each ear for various positions of the sound source. The sound source A21 represents a first position in which the sound source is on the side of the left ear of the listener and the sound source A22 represents a second position in which the sound source is on the side of the right ear of the listener. The sound source A21 is closer to the listener than the source A22 is.
Therefore, if S₁(t)=ƒ(t) where f is the function defined in the formula (1), then S₂(t)=ƒ(t+Δt) (formula (2)) where S1 is the signal received at the left ear and S2 the signal received at the right ear.
On the time line of S1(t) has been shown both the sound SA21 of the sound source when it is in position A21 and also the sound SA22 when it is in position A22. The same is shown for the line S2(t).
The sound SA21 arrives earlier at the left ear than the right ear because the sound is positioned on the side of the left ear.
The sound SA22 arrives earlier at the right ear than the left ear because the sound A22 is positioned on the side of the right ear.
On one and the same time scale, the sound SA21 arrives before the sound SA22 because the sound source A21 is closer to the listener than the source A22 is.

For the computation of the trajectory 32 of the oscillatory movement around the virtual position of origin 33 and in the situation in which the head is assimilated to a sphere and in which sufficiently long waveforms are considered, for the computation of the ITD signals, the interaural time difference for a given azimuth θ varies between

$$Δ t = \frac{3 a}{c} \cdot sin θ$$

$$and$$

$$Δ T = \frac{3 a}{c} \cdot sin ( θ + Angular step ) ,$$

where θ is the angle in azimuth a1 in FIG. 5. The angle values changing in the angular step range are used for computing the various virtual positions forming the trajectory 32. These values are injected into the formula 2. The various angle values in the range of angular step define the various virtual positions comprising the trajectory of the sound signal. The sounds must have a frequency that is ideally less than 70 ms in order to prevent the artificial effects of drag when the head is turned. In the same manner, the overall sound imprint should ideally last for at least 250 ms.

Computation of the ILD Signals:

The sound intensity is different between the left ear and the right ear of a listener. The difference in sound level is variable according to an angle between the two ears.

The sound level difference between the two ears varies between the ILD curve associated with the virtual position of origin 33 of the sound signal and the ILD curve associated with the extreme position of the sound signal on the trajectory of movement. The sound difference varies as a function of the angular steps 44 and 45 (azimuth and elevation). FIG. 1 illustrates, for example, a law of sound intensity that can be applied to the sounds.

The value of the angular steps 44 and 45 varies as a function of the orientation of the pilot. The law of regulation of the steps cited above shows that the more the listener is oriented towards the position of origin of the sound signal, the more the value of the angular steps diminishes, until the steps disappear for a direction that is substantially equal to the direction of the virtual position of origin. The device 6 for detecting position transmits the position coordinates to the computation means 3 and according to these coordinates the angular steps 44 and 45 will diminish or increase. The diagram on the right of FIG. 3 corresponds to a situation in which the orientation of the pilot is close to the virtual position of origin 33 of the sound signal. The angle of deviation 36 is reduced and consequently the new trajectory 41 computed by the computation module 2 is of smaller amplitude, delimited by the two positions 36 and 37.

The values of the HRTFs are still used based on the predetermination made for each subject and described above.

In addition to the ILDs, the invention also comprises, for each subject, a computation means 4 for processing the sound signal at the output of the sound spatialization computation means 2. This module 4 varies the sound intensity of a sound signal as a function of the positions of the sound on the oscillatory movement.

Preferably, a law of regulation of the linear sound is applied to a spatialized sound making the oscillatory movement so that the intensity 39 of the sound signal is diminished by a predefined number of dB when the position of the sound signal is localized in an extreme position of the oscillatory movement. These positions correspond, in FIG. 3, to the positions 34 and 35 of the oscillatory movement 32, and the intensity 40 of the sound signal is maximum when the position of the sound signal is localized on the virtual position of origin 33 of the sound signal. A law of linear regression may, for example, determine the intermediate positions having a level of sound intensity that is intermediate between the maximum intensity and the diminished intensity.

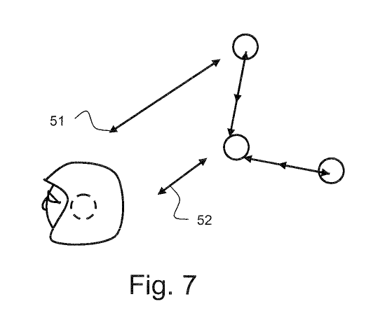

As shown by FIG. 7, the sound processing module makes it possible:
to simulate a distancing relative to the position of the sound signal when the positions of the sound signal during the oscillatory movement come close to an extreme position of the oscillatory movement,
to simulate the sound signal coming closer when the positions of the signal during the oscillatory movement come close to the virtual position of origin of the spatialized sound.

Specifically, the intensity of the sound signal is less strong for a signal moved away from its real position. For the listener, this variation in intensity simulates a distance 51 between the listener and a high extreme position of the oscillatory movement, while, for the virtual position of origin, the simulated distance 52 is small. The modification of intensity simulates a spatial convergence of the oscillatory movement towards the position of origin. The law of variation of sound intensity may be independent of the angle of deviation between what the pilot is looking at and the direction of the sound source. The variation may also be random, that is to say non-continuous between the position of origin and the extremes.

Preferably, the duration of a sound is greater than 250 ms. Ideally, the duration should even be greater than 5 s in order to take full advantage of the associated dynamic signals.

Any type of sound delivery system may be used: a system comprising a loudspeaker, a system comprising several loudspeakers, a system of cartilaginous transducers, a system of plugs with or without wires, etc.

The sound spatialization method applies to any type of application in which the needs require the localization of a sound. It is addressed particularly to applications associating a sound with an item of information that must be taken into account by a listener. It applies to the aeronautics field for the man-machine interaction of the avionics systems with the pilot, for applications of simulators immersing an individual (a virtual reality system for example or an aircraft simulator) and also to the motor vehicle field for systems that have to warn the driver of a danger and supply information on the origin of the danger.

1. Method for algorithmic processing of signals for sound spatialization making it possible to associate sound signals with information that has to be located by a listener, the spatialized sound signals being defined by a virtual position of origin corresponding to the position of the information, wherein, by algorithmic processing, a spatialized sound signal has a movement applied to it describing a sequence of virtual positions of the said signal around the virtual position of origin of the information and, during the movement of the spatialized signal, a law of variation of the sound intensity is applied to the spatialized signal, the sound intensity being between a maximum level and a minimum level, the level being maximum when the sound signal corresponds to the virtual position of origin and the level being minimum for the extreme positions of the movement.

2. Method according to claim 1, wherein the movement around the virtual position of origin of the information is of the oscillatory type.

3. Method according to claim 1, wherein the movement around the virtual position of origin of the information is of the Random type.

4. Method according to claim 2, wherein the movement is correlated with the angle of deviation between the direction in which the listener is looking and the virtual position of origin of the said sound signal.

5. Method according to claim 4, wherein the amplitude of the oscillatory movement is correlated with the value of the said angle of deviation.

6. Method according to claim 5, wherein the orientation of the oscillatory movement is correlated with the orientation of the plane of the said angle of deviation.

7. Method according to claim 3, wherein the movement is correlated with the angle of deviation between the direction in which the listener is looking and the virtual position of origin of the said sound signal.

8. Method according to claim 7, wherein the amplitude of the oscillatory movement is correlated with the value of the said angle of deviation.

9. Method according to claim 8, wherein the orientation of the oscillatory movement is correlated with the orientation of the plane of the said angle of deviation.

10. System for algorithmic processing of signals for sound spatialization comprising a first sound spatialization computation means making it possible to associate sound signals with information that has to be located by a listener, the spatialized sound signals being defined by a virtual position of origin corresponding to the position of an item of information, comprising a second trajectory computation means supplying data making it possible for the first spatialization computation means to apply a movement to a spatialized sound signal around its virtual position of origin and comprising a third means for computing at least one law of variation of the intensity of a sound signal in order to modify the intensity of the spatialized sound signal during the oscillatory movement.

11. System according to claim 10, comprising a means for receiving position data and the second trajectory computation means computes the angle of deviation between the virtual position of origin of the sound source and the position supplied by the reception means and computes an oscillatory movement in correlation with the said angle of deviation.

12. System according to claim 11, wherein the means for receiving position data is linked to a detector of the position of a helmet worn by a listener.

13. System according to claim 12, wherein the means for receiving position data is linked to a camera that is not worn by the listener and is detecting the positioning of the listener.

14. System according to claim 13, wherein the sound signals originate from a sound database of an aircraft and in that the said sound signals are associated with information of at least one avionics device.

15. System according to claim 14, wherein a first avionics device is a display device.

16. System according to claim 15, wherein a second avionics device is a navigation device.

17. System according to claim 16, wherein a third avionics device is a warning device.
